(19) United States
(12) Patent Application Publication
(10) Pub. No.: US 2007/0083624 A1
(43) Pub. Date: Apr. 12, 2007

(54) Method and system for providing service to wireless devices operating in a power saving mode

(75) Inventor: Amjad Soomro, Hopewell Junction, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/578,646

(22) PCT Filed: Nov. 8, 2004
(86) PCT No.: PCT/IB04/52343

§ 371 Date: May 9, 2006

Related U.S. Application Data
(60) Provisional application No. 60/518,907, filed on Nov. 10, 2003.
(60) Provisional application No. 60/575,277, filed on May 28, 2004.

(51) Int. Cl. G06F 15/173

(52) U.S. Cl. 709/223

(57) ABSTRACT

A method and system for a network component (700) for determining when to provide services to power saving client devices (701) is disclosed. The method comprising the steps of receiving a requested servicing method (420) from the client device (701), determining an ability to accommodate (420, 510, 630) the requested servicing method, and providing an indication of the ability to accommodate (435, 450, 470) the requested servicing method to the client device. In one aspect of the invention the ability to accommodate is based on at least one factor selected from the group consisting of, the requested service method, a proposed schedule, current demand at the network component, and the current operating state of the network component (420, 510, 630).

This application claims the benefit, pursuant to 35 USC §119(e), to that provisional patent application filed on Nov. 10, 2003 in the United States Patent and Trademark Office and assigned Ser. No. 60/518,907, the contents of which are incorporated by reference herein.

This application relates to wireless communications and, more particularly, to providing services to client devices utilizing power saving capabilities.

Wireless networking of servers, routers, access points and client devices has greatly expanded the ability of users to create and expand existing networks. Further, wireless network can be dynamically modified as users join or the network. In fact, wireless networks have allowed clients to connect devices as such as notebook or laptop computers, Personal Digital Assistants (PDAs), cell phones, to office and home networks from remote locations not typically associated with the network. Such remote locations, referred to as hot spots, allow clients to access their own networks from local coffee shops.

To facilitate the wireless communication explosion and provide compatibility among different devices, communications protocols, such as IEEE 802.11a/b/g have been established. However, these protocols are designed primarily for the transmission of data and treat all data equally. Such equal treatment precludes a service provider from guaranteeing a known Quality of Service (QoS) when the data transmitted includes a mix of textual data, video, audio or telephony. Failure to timely deliver video data, for example, may cause errors in motion rending the images unusable. Hence, the IEEE 802.11e standard has been proposed that establishes a priority of transmission for different types of data. In one aspect, a priority is established based simply on the data type. In another aspect, parameters may be assigned to specific data types to insure a specified QoS.

An important aspect of the network client devices is that they are battery operated. Thus, many of these devices desire to conserve power and operate in a power saving mode. In this mode, the client devices are not powered and, thus, are not able to receive data from service providers operating at the routers, servers, or access points when transmission is required. Rather, a client device may request that the service provider provide service at predetermined times, i.e., scheduled, or on-demand, i.e., unscheduled. However, as more devices enter and demand service from the network, the demands of individual devices can introduce conflicts in one or more network components, i.e., servers, routers, access points, etc., or there may be requests that the network may not be able to ho nor.

Hence, there is a need in the industry for a method and system for processing client device requests for service that is able to avoid and/or resolve conflicts that can be introduced by such requests.

A method and system for a network component for determining when to provide services to power saving client devices is disclosed. The method comprising the steps of receiving a requested servicing method from the client device, determining an ability to accommodate the requested servicing method, and providing an indication of the ability to accommodate the requested servicing method to the client device. In one aspect of the invention the ability to accommodate is based on at least one factor selected from the group consisting of, the requested service method, a proposed schedule, current demand at the network component, and the current operating state of the network component.

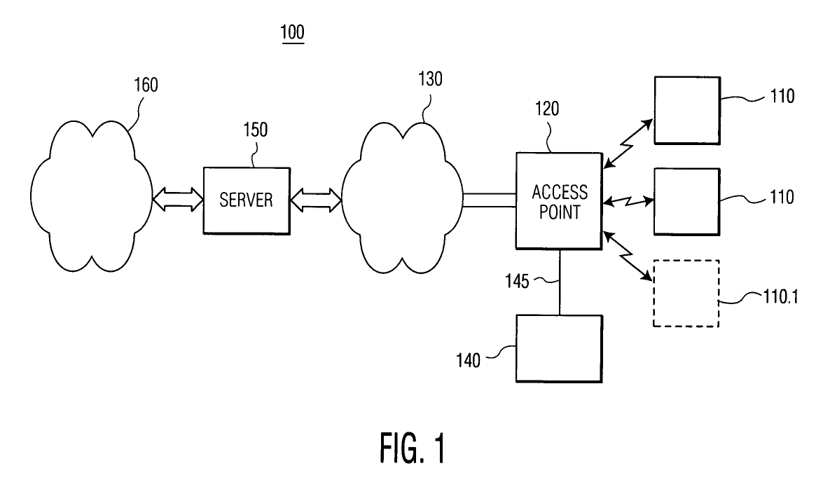

FIG. 1 illustrates a conventional wireless communication system;

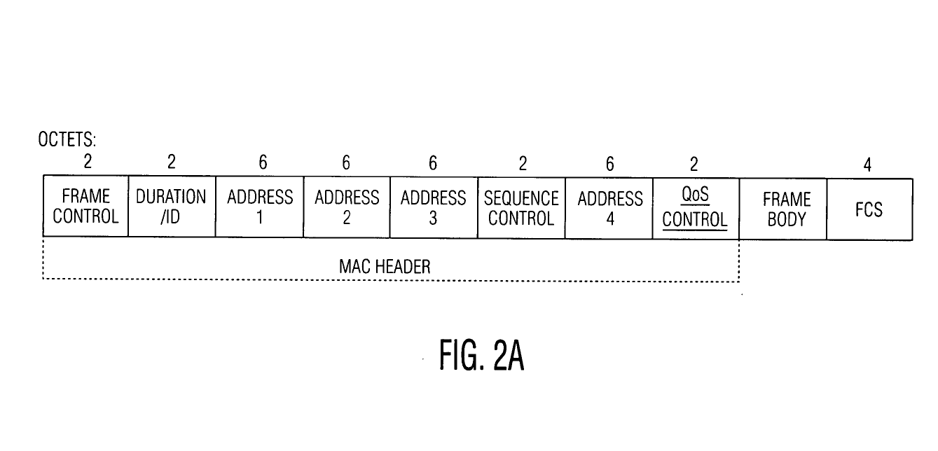

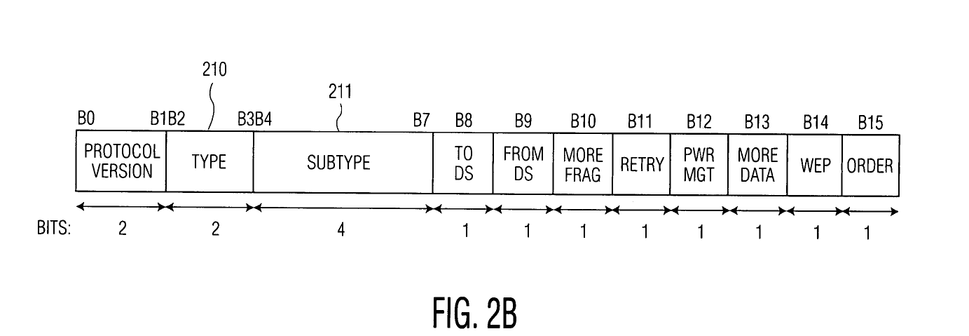

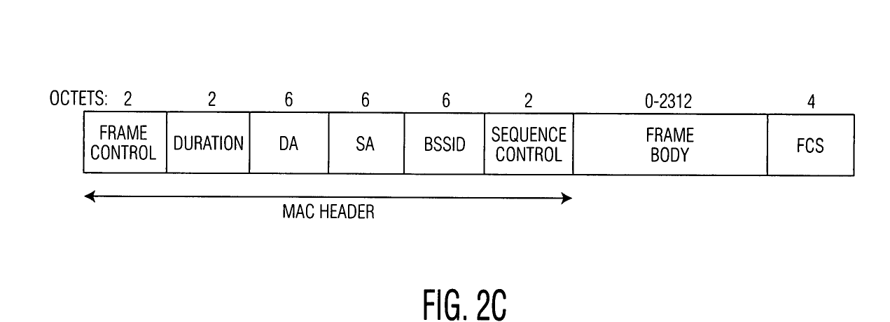

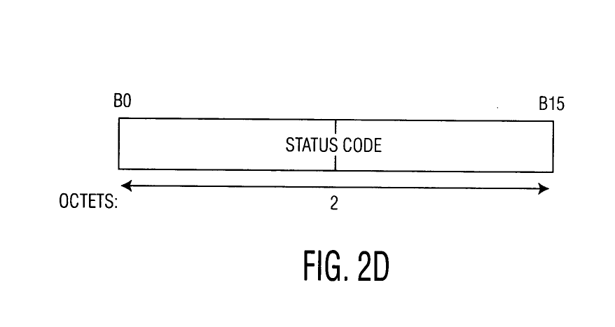

FIGS. 2a-2d illustrate MAC layer formats for the proposed IEEE 802.11e standard;

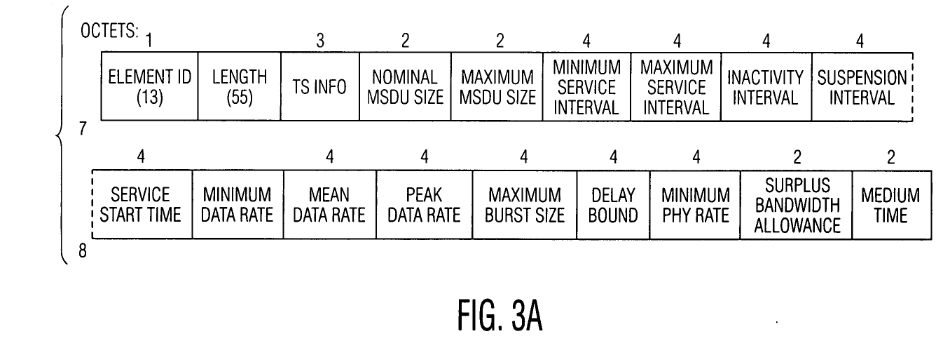

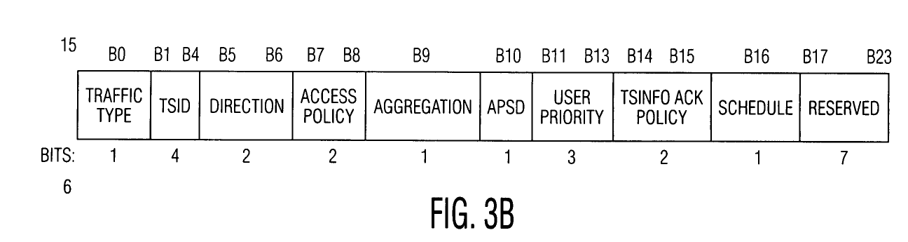

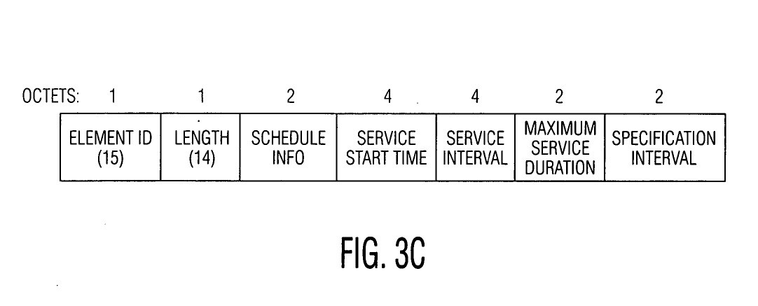

FIGS. 3a-3c illustrates traffic specification element formats between a requesting device and network component;

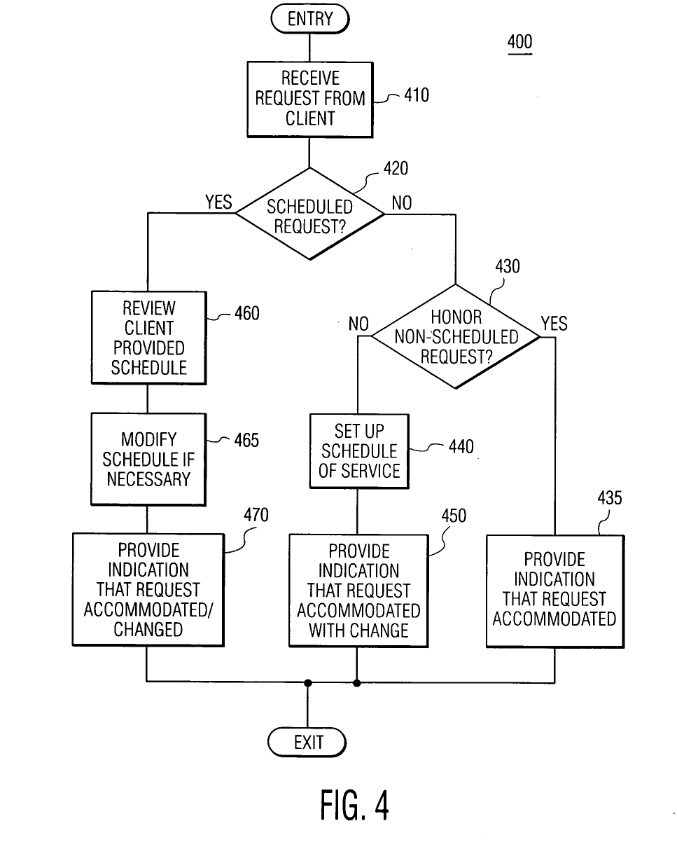

FIG. 4 illustrates a flow chart for providing service to client devices operating in power-saving mode in accordance with a first aspect of the invention;

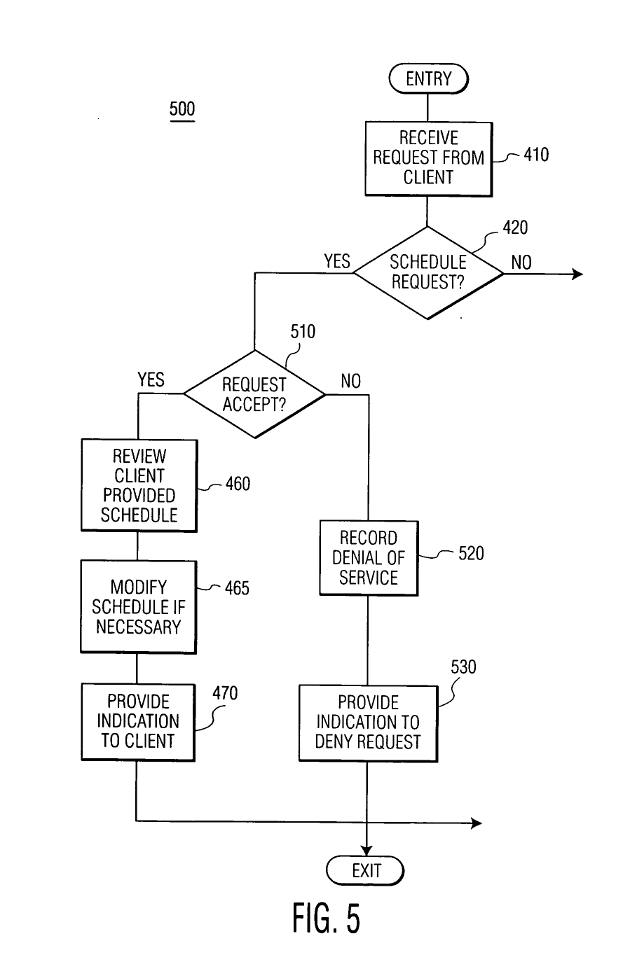

FIG. 5 illustrates a flow chart for providing service to client devices operating in power-saving mode in accordance with a second aspect of the invention;

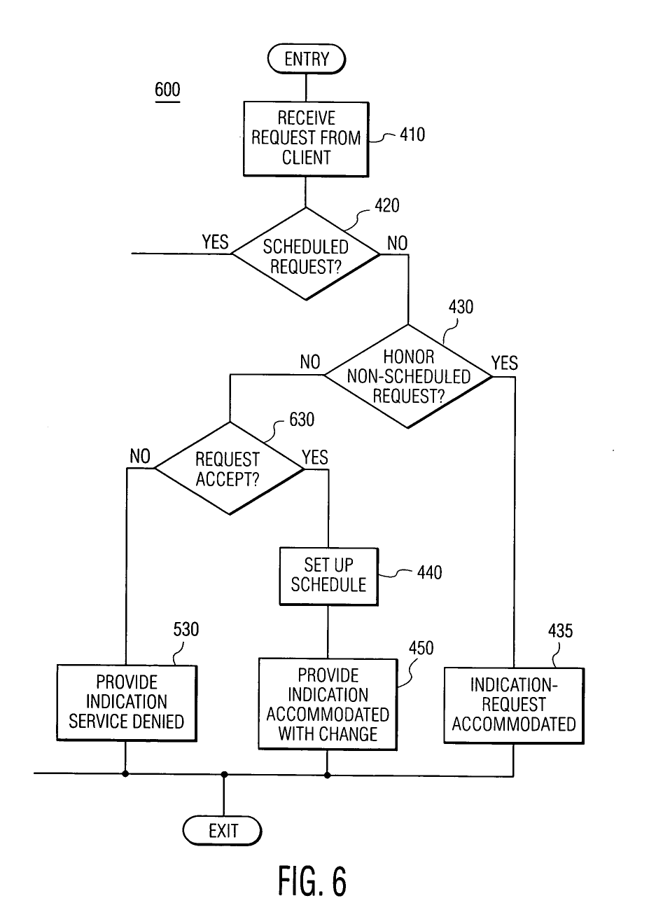

FIG. 6 illustrates a flow chart for providing service to client devices operating in power-saving mode in accordance with a second aspect of the invention; and

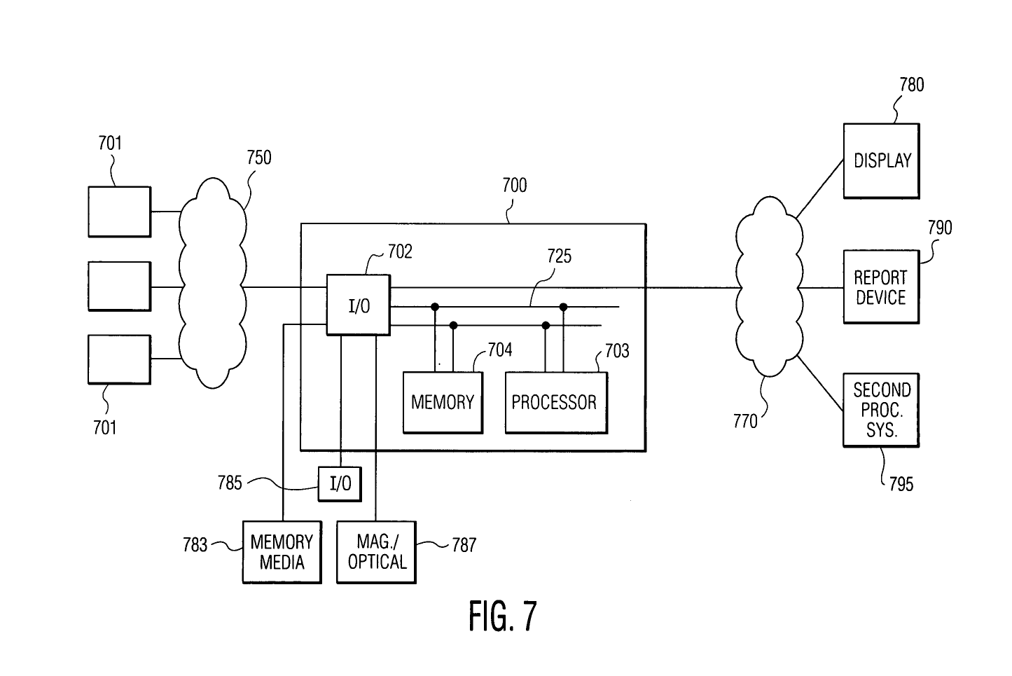

FIG. 7 illustrates a system for executing the processing shown in herein.

It is to be understood that these drawings are solely for purposes of illustrating the concepts of the invention and are not intended as a definition of the limits of the invention. The embodiments shown in the figures herein and described in the accompanying detailed description are to be used as illustrative embodiments and should not be construed as the only manner of practicing the invention. Also, the same reference numerals, possibly supplemented with reference characters where appropriate, have been used to identify similar elements.

FIG. 1 illustrates a conventional based wireless network 100 that can allow wireless devices 110, through server, router or access point (AP) 120 to receive or transmit data to communication network 130, e.g., the Internet. AP 120 may further enable devices 140, connected via a cable 145, to receive and transmit data to network 130 and/or to devices 110. Also shown is network 130 in communication with server 150, which may also be in communication with a second network 160. As would be recognized second network 160 and network 130 may be the same or different network. In this illustrative example, network 130 may be a network associated with a local hot spot and network 160 may be a corporate or home network that permits access by only authorized users.

Device 110.1, shown in dotted lines, represents a client device that is dynamically joined through AP 120 to network 130. In this case, AP 120 must acknowledge the addition of device 110.1 and accommodate its requests for service in view of the existing load imposed by the already connected devices 110 and 140.

FIG. 2a illustrates a proposed IEEE 802.11e MAC layer data format. FIG. 2b illustrates the format of the Frame Control field of the MAC layer. The frame control field shown in FIG. 2b includes two (2) bits for type, 210 and four (4) bits for subtype, 211 that determine whether the next frame is of a MAC Layer Data, Management or Control format FIG. 2b also includes a Power Management field that is used to indicate the power management mode of a client device. In one mode a value of “1” in the power management field indicates that the client device is in a power saving mode. A value of “0” indicates that the client device is always in an active mode.

FIG. 2c illustrates a proposed MAC layer Management Frame format which includes two-byte Frame Control field that determined the type of Management Frame Format. For example, Management Frame Format can be Request (association, probe, action, add TS action, block acknowledgement), and Response (association, probe, action, add TS action, block acknowledgement), etc. Within the Action request there are QoS, DLP and block acknowledgment actions. Furthermore, with the QoS action request there is the sub-request for “Add Traffic Specification” (AddTS), and, also a response to the AddTS request. The response to the request AddTS includes a Status Code Fixed Field that is used a Response Management Frame to indicate the success or failure of a requested operation. FIG. 2d illustrates the two (2) byte Status Code Field. An example of Status Code Fields are shown in Table 1.

TABLE 1
Exemplary Status Code Field Definitions

| | |
|---|---|
| 32 | Unspecified, QoS-related failure |
| 33 | Association denied due to QAP having insufficient bandwidth to handle another QSTA |
| 34 | Association denied due to excessive frame loss rates and/or poor conditions on current |
| | operating channel |
| 35 | Association (with QBSS) denied due to requesting station not supporting the QoS facility |
| 37 | The request has been declined. |
| 38 | The request has not been successful as one or more parameters have invalid values. |
| 39 | The TS has not been created because the request cannot be honored. However, a |
| | suggested TSPEC is provided so that the initiating QSTA may attempt to set another TS |
| | with the suggested changes to the TSPEC. |
| 40 | The TS has not been created. However, the HC may be capable of creating a TS, in |
| | response to a request, after the time indicated in the TS Delay element. |
| 41 | Direct Link is not allowed in the BSS by policy |
| 42 | Destination STA is not present within this QBSS. |
| 43 | The Destination STA is not a QSTA. |

FIG. 3a illustrates a Traffic Specification format used to set up communicate between a client device and a network access point. FIG. 3b illustrates the format of the TS Info field within the Traffic Specification format shown in FIG. 3a. As shown, the TS Info field includes an Automatic Power Saving Delivery (APSD) field and a Schedule field. The APSD field, when set, informs the AP that the client device is operating in a power saving mode and the schedule field, when set, informs the AP that the client device requests that services be provided on a proposed scheduled basis. In this manner, the client device may awaken from the power saving mode at a time just before the expected transmission of the requested service. FIG. 3c illustrates a format for a proposed schedule.

FIG. 4 illustrates a flow chart of an exemplary processing 400 for processing request from a client device in accordance with the principles of the invention. In this Illustrated process, a service request is received at block 410. At block 420 a determination is made whether the service requested is to be provided on a scheduled basis. In one aspect of the invention, a scheduled based service may be requested by setting the “schedule bit” shown in FIG. 3b. If the answer is negative, then a determination is made, at block 430, whether the service provider can honor the non-scheduled, i.e., the “unscheduled” request. If the answer is in the affirmative, then an indication is returned to the requesting client device, at block 435, that the requested service can be accommodated. In one aspect, the indication may include setting the “schedule bit”, shown in FIG. 3b to a first logical value, e.g., a zero value.

However, if the answer is negative, then a schedule for providing service to the requesting client device is determined at block 440. The provide schedule may be based on current and projected operating demands, loads and processing capability. An indication is then returned to the requesting client device, at block 450, that the service is accommodated with change. In one aspect, the indication may include setting the “schedule bit”, shown in FIG. 3b to a second logical value, e.g., a one value. In addition, the determined schedule is also provided to the requesting client device.

Returning to the determination at block 420, if the answer is affirmative, then the service provider reviews the requested schedule at block 460. At block 465, the service provider may modify the proposed schedule. Modifications of the proposed schedule may be necessary based on factors such as conflicts with existing schedules, station loading, current demands, current loads, projected demands, projected loads and/or other processing considerations.

At block 470, an indication is then returned to the requesting client device that the requested service is accommodated or accommodated with change. In one aspect, the indication may include setting the “schedule bit”, shown in FIG. 3b, to a second logical value, e.g., a one value. In addition, the schedule of service, whether as-proposed or as-requested by the client device or modified by a network component, e.g., AP 120, is also provided to the requesting client device.

FIG. 5 illustrates a flow chart of a second aspect 500 of the processing shown in FIG. 4. In this illustrative aspect of the invention, after determining, at block 420, that a request for scheduled service was received, a determination is made, at block 510, whether the network policy and/or network conditions allow accepting the request. If the answer is in the affirmative then the processing proceeds to review the proposed schedule, modify it, if necessary, and transmit an indication of scheduled service as discussed with regard to processing shown in FIG. 4 at blocks 460, 465 and 470.

However, if the answer is negative, then an indication is provided to the requesting device that the request for service has been denied at block 530. Service may be denied, for example, if AP 120 is operating in an on-demand only mode and has no provisions for preparing a schedule. Although not shown, it would be recognized that a review of the client proposed schedule may be made prior to the determination at block 510 and a denial of service may also occur if the proposed schedule cannot be accommodated in view of the current demand and load requirements placed on the AP 120.

FIG. 6 illustrates a flow chart of a third aspect 600 of the present invention. In this aspect, when it is determined, at block 420, that the requested service is an unscheduled service, a determination is made at block 430 whether the AP 120 (service provider) can honor the requested service. If the answer is in the affirmative, then an indication is provided to the requesting device as previously discussed with regard to processing block 435 (see FIG. 4).

However, if the answer at block 430 is negative, then a determination is made at block 630 whether network policy and/or network conditions allow accepting the request. If the answer is in the affirmative, then a schedule is set up and an indication is provided to the requesting device as previously discussed with regard to processing blocks 440 and 450 as shown in FIG. 4.

However, if the answer is negative, then an indication is provided to the requesting device that the requested service is denied at block 530.

In one aspect of the invention, the indication provided to the requesting client device communicating using an IEEE 802.11e communication protocol, may, for example, be formed as a combination of data items shown in FIG. 2. For example, the indication may be formulated as shown in Table 2.

TABLE 2
Proposed Indication Configuration

| | Status | | Sched. | |
|---|---|---|---|---|
| Operation | Code | APSD | Bit | |
| Requested Unscheduled | 00 | 1 | 0 | Accommodated |
| service | | | | |
| Requested Scheduled | 00 | 1 | 1 | Accommodated |
| service | | | | |
| Requested Unscheduled | 00 | 1 | 1 | Accommodated |
| service | | | | with change |
| Requested Scheduled | 00 | 1 | 1 | Accommodated |
| service | | | | with change |
| Requested Unscheduled | 37 | X | X | Denied |
| service | | | | |
| Requested Scheduled | 37 | X | X | Denied |
| service | | | | |

X = don't care

FIG. 7 illustrates an exemplary embodiment of a system 700 that may be used for implementing the principles of the present invention. System 700 may contain one or more input/output devices 702, processors 703 and memories 704. I/O devices 702 may access or receive information from one or more sources 701 that request services from processor(s) 703. Client devices 701 may be devices such as a television system, computers, notebook computer, PDAs, cells phones or other portable devices. Devices 701 may request access over one or more network connections 750 via, for example, a wireless wide area network, a wireless metropolitan area network, a wireless local area network, a terrestrial broadcast system (Radio, TV), a satellite network, a cell phone, or a wireless telephone network, as well as portions or combinations of these and other types of networks.

Input/output devices 702, processors 703 and memories 704 may communicate over a communication medium 725. Communication medium 725 may represent, for example, a bus, a communication network, one or more internal connections of a circuit, circuit card or other apparatus, as well as portions and combinations of these and other communication media. Input data requests from the client devices 701 is processed in accordance with one or more programs that may be stored in memories 704 and executed by processors 703. Processors 703 may be any means, such as general purpose or special purpose computing system, or may be a hardware configuration, such as a laptop computer, desktop computer, a server, handheld computer, dedicated logic circuit, or integrated circuit. Processors 703 may also be Programmable Array Logic (PAL), Application Specific Integrated Circuit (ASIC), etc., which may be hardware “programmed” to include software instructions that provide a known output in response to known inputs. In one aspect, hardware circuitry may be used in place of, or in combination with, software instructions to implement the invention. The elements illustrated herein may also be implemented as discrete hardware elements that are operable to perform the operations shown using coded logical operations or by executing hardware executable code.

In a one aspect, the principles of the present invention may be implemented by computer readable code executed by processor 703. The code may be stored in the memory 704 or read/downloaded from a memory medium 783, an I/O device 785 or magnetic, optical media such as a floppy disk, a CD-ROM or a DVD.

Requests from the device 701 received by I/O device 702 after processing in accordance with one or more software programs operable to perform the functions illustrated herein may also be transmitted over network 770 to one or more output devices represented as display 780, reporting device 790 or second processing system 795. As discussed with regard to FIGS. 4-6, an indication responsive to the requested service is returned to the requesting device. The returned indication typically is provided through network 630 but may be provided by other communication media (not shown).

As one skilled in the art would recognize, the term computer or computer system may represent one or more processing units in communication with one or more memory units and other devices, e.g., peripherals, connected electronically to and communicating with the at least one processing unit. Furthermore, the devices may be electronically connected to the one or more processing units via internal busses, e.g., ISA bus, microchannel bus, PCI bus, PCMCIA bus, etc., or one or more internal connections of a circuit, circuit card or other device, as well as portions and combinations of these and other communication media or an external network, e.g., the Internet and Intranet.

While there has been shown, described, and pointed out fundamental novel features of the present invention as applied to preferred embodiments thereof, it will be understood that various omissions and substitutions and changes in the apparatus described, in the form and details of the devices disclosed, and in their operation, may be made by those skilled in the art without departing from the spirit of the present invention. It is expressly intended that all combinations of those elements that perform substantially the same function in substantially the same way to achieve the same results are within the scope of the invention. Substitutions of elements from one described embodiment to another are also fully intended and contemplated.

What is claimed is:

1. A method for determining in a network component when to provide service to client devices operating in power-saving mode in a wireless network, said method comprising the steps of:
receiving a requested servicing signal (410) from said client device; determining an ability to accommodate said requested servicing signal (420); and
providing an indication of the ability to accommodate said requested servicing signal (435, 450, 470) to said client device.

2. The method as recited in claim 1, wherein said requested servicing signal is selected from the group consisting of: scheduled and unscheduled.

3. The method as recited in claim 2, wherein said scheduled requested servicing signal includes a proposed service schedule (460).

4. The method as recited in claim 3, further comprising the step of:
modifying said proposed service schedule (465).

5. The method as recited in claim 4, further comprising the step of:
providing said modified service schedule to said client device (470).

6. The method as recited in claim 1, wherein said indication is selected from the group consisting of: denied, accommodated with change, accommodated (435, 450, 470).

7. The method as recited in claim 1, wherein the step of determining an ability to accommodate is based on at least one factor selected from the group consisting of: the requested servicing method, the proposed schedule, network operating state, network policy, and network condition (510, 630).

8. A device for determining in a network component when to provide service to client devices operating in power-saving mode in a wireless network, said device comprising:
a memory (704);
a processor (703) in communication with said memory, said processor operable to execute code for:
receiving a requested servicing signal (410) from said client device (701);
determining an ability to accommodate said requested servicing signal (420); and
providing an indication of the ability to accommodate said requested servicing signal (435, 450, 470) to said client device.

9. The device as recited in claim 8, wherein said requested servicing signal is selected from the group consisting of: scheduled and unscheduled.

10. The device as recited in claim 9, wherein said scheduled requested servicing signal includes a proposed service schedule (460).

11. The device as recited in claim 10, wherein said processor is further operable to execute code for:
modifying said, proposed service schedule (465).

12. The device as recited in claim 11, wherein said processor is further operable to execute code for:
providing said modified service schedule to said client device (470).

13. The device as recited in claim 8, wherein said indication is selected from the group consisting of:
denied, accommodated with change, accommodated (435, 450, 470).

14. The device as recited in claim 1, wherein said processor is further operable to execute code for:
determining said ability to accommodate based on at least one factor selected from the group consisting of: the requested servicing method, the proposed schedule, network operating state, network policy, and network condition (430, 510, 630).

15. The device as recited in claim 8, further comprising:
an I/O device (702) operable as an interface between said network and said processor.

16. The device as recited in claim 8, wherein said code is stored in said memory.

17. The device as recited in claim 8, further comprising:
a receiving device for receiving said requested service method; and
a transmitting device for providing at least said indication to said client device.

18. A processor (703) within a network component (700) for determining the ability of said network component to honor a servicing request signal receiving from a client device (701), said processor executing code for:
reviewing an operating state of said network component (430, 510, 630);
reviewing said servicing request signal (420);
accommodating said servicing request signal, with modification when necessary, when said operating state and said servicing request signal are corresponding (435, 470); and
providing an indication of said accommodation to said client device.

19. The processor as recited in claim 18, further executing code for:
providing an indication of denying said servicing request signal when said operating state and said servicing request signal are not corresponding (530).

20. The processor as recited in claim 18, wherein said operating state is selected from the group consisting of: processing load, demand, projected processing load, projected demand, network component operating state, network component policy, and network component condition.

21. The processor as recited in claim 18, wherein said servicing request signal is selected from the group consisting of: scheduled and unscheduled.
